(19) United States
(12) Patent Application Publication
(10) Pub. No.: US 2017/0136961 A1
(43) Pub. Date: May 18, 2017

(54) IMAGING SYSTEM

(71) Applicant: TOYOTA JIDOSHA KABUSHIKI KAISHA, Toyota-shi (JP)

(72) Inventors: Hiroshi HARADA, Nagakute-shi (JP); Yoshifusa DEMIZU, Nisshin-shi (JP); Tomoyasu TAMAOKI, Okazaki-shi (JP); Hirotaka HATAKEYAMA, Nagoya-shi (JP)

(73) Assignee: TOYOTA JIDOSHA KABUSHIKI KAISHA, Toyota-Shi (JP)

(21) Appl. No.: 15/263,826

(22) Filed: Sep. 13, 2016

(30) Foreign Application Priority Data
Nov. 12, 2015 (JP) 2015-221853

(51) Int. Cl. B60R 11/04; H05B 3/86; H04N 7/18

(52) U.S. Cl. CPC B60R 11/04; H04N 7/18; H05B 3/86; B60R 2011/0026

(57) ABSTRACT

A camera captures an image of objects outside a vehicle through a window of the vehicle. An image processing unit determines whether a captured image captured by the camera is clear or blurred. A controller activates a window heater to raise a temperature of a window area if the image processing unit determines that the captured image is blurred. If a blurred state of the captured image is not reduced by a time that a predetermined period of time elapses since the window heater is activated, the controller suspends activation of the window heater when the predetermined period of time elapses and prohibits subsequent activation of the window heater.

The disclosure of Japanese Patent Application No. 2015-221853 filed on Nov. 12, 2015 including the specification, drawings and abstract is incorporated herein by reference in its entirety.

### BACKGROUND

1. Technical Field

The present disclosure relates to an imaging system mounted to a vehicle.

2. Description of Related Art

Systems in which a camera is installed in a vehicle interior to capture an image of objects outside the vehicle through a window are known to date. A driving assistance system mounted to a vehicle assists driving by, for example, detecting a pedestrian or another vehicle around the vehicle by referring to an image captured by an on-vehicle camera through the window and outputting an alert to the driver. If a window area included in an imaging range of the on-vehicle camera is fogged, the on-vehicle camera cannot capture an image of objects outside the vehicle properly. This forces the driving assistance system to stop the driving assistance process based on captured images. It is therefore suitable to prevent or remove the fog (condensation) on the window so that the on-vehicle camera can capture an image of objects outside the vehicle properly.

JP-A-2004-112329 discloses an imaging system for capturing an image of objects outside the vehicle through the window of the vehicle. The imaging system disclosed in JP-A-2004-112329 is provided with a hot wire in the window area included in the imaging range of the on-vehicle camera in order to raise the temperature of the window. When it is determined that the window is fogged by referring to an image captured by the on-vehicle camera, the hot wire is used to generate heat so as to remove the fog on the window. Meanwhile, activation of the hot wire is prohibited so as not to use electric power wastefully while the window is not fogged.

It is indeed possible to provide a dedicated fog detection sensor in order to determine whether the window is fogged. On the other hand, as disclosed in JP-A-2004-112329, by employing a scheme to determine that the window is fogged by detecting a blurred captured image, there should be no need to provide the dedicated sensor, resulting in lower cost. According to this scheme, however, a blurred captured image is detected even when the window becomes dirty with, for example, mud while the vehicle is traveling. According to the technology of JP-A-2004-112329, the hot wire continues to be activated while blurred captured images are being detected even though the blurred images are not due to fogging of the window. In this kind of situation, because the attached dirt is not removed by heating the window, electric power is consumed wastefully.

### SUMMARY

The embodiments address this background and a general purpose thereof is to provide a technology for reducing wasteful consumption of electric power in the process of removing the blur on a captured image.

The imaging system according to one embodiment is configured to be mounted to a vehicle and comprises: a camera configured to capture an image of objects outside the vehicle through a window of the vehicle; a window heater configured to raise a temperature of at least a window area included in an imaging range of the camera; an image processor configured to determine whether a captured image captured by the camera is clear or blurred; and a controller configured to activate the window heater to raise the temperature of the window area when the image processor determines that the captured image is blurred. When a blurred state of the captured image is not dissolved (eliminated or reduced) by a time that a predetermined period of time elapses since the window heater is activated, the controller suspends activation of the window heater once the predetermined period of time has elapsed and prohibits the subsequent activation of the window heater.

If the blurred state of the captured image is not dissolved (eliminated or reduced) by the time the predetermined period of time elapses since the window heater is activated, it is likely that the captured image is blurred due to dirt on the window instead of fog (condensation) or ice coating on the window. By prohibiting the subsequent activation of the window heater according to the embodiment, wasteful consumption of electric power is reduced.

The image processor has a function of determining whether the blurred state of the captured image is dissolved (eliminated or reduced). When the image processor determines that the blurred state of the captured image is not dissolved (eliminated or reduced) once the predetermined period of time has elapsed since the window heater is activated, the controller prohibits the subsequent activation of the window heater. This can reduce wasteful consumption of electric power.

The image processor has a function of determining whether the blurred state of the captured image is dissolved (eliminated or reduced). When the image processor determines that the blurred state of the captured image is dissolved (eliminated or reduced) before the predetermined period of time has elapsed since the window heater is activated, the controller does not prohibit the activation of the window heater after the predetermined period of time has elapsed. By permitting the activation of the window heater even after the predetermined period of time elapses based on a determination that the captured image is cleared by activating the window heater, generation of fog or ice coating on the window can be prevented or removed effectively.

When the image processor determines that the blurred state of the captured image is dissolved (eliminated or reduced) while the activation of the window heater is being prohibited, the controller may cancel prohibition of activation of the window heater. By allowing the controller to immediately return to a state in which it can activate the window heater when the dirt on the window has been removed, the fog or ice coating on the window that occurs subsequently can be removed by activating the window heater.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 shows an imaging system mounted to a vehicle;

FIG. 2 shows the configuration of the processing device;

FIGS. 3A and 3B show examples of images captured by the camera;

FIG. 4 is a flowchart showing the imaging state determination process;

FIG. 5 is an exemplary flowchart for temperature raising control;

FIG. 6 is an exemplary timing chart for temperature raising control;

FIG. 7 is another exemplary timing chart for temperature raising control; and

FIG. 8 is another exemplary flowchart for temperature raising control.

### DETAILED DESCRIPTION

Various embodiments will now be described by reference to the drawings. The embodiments are illustrative and are not intended to be limiting.

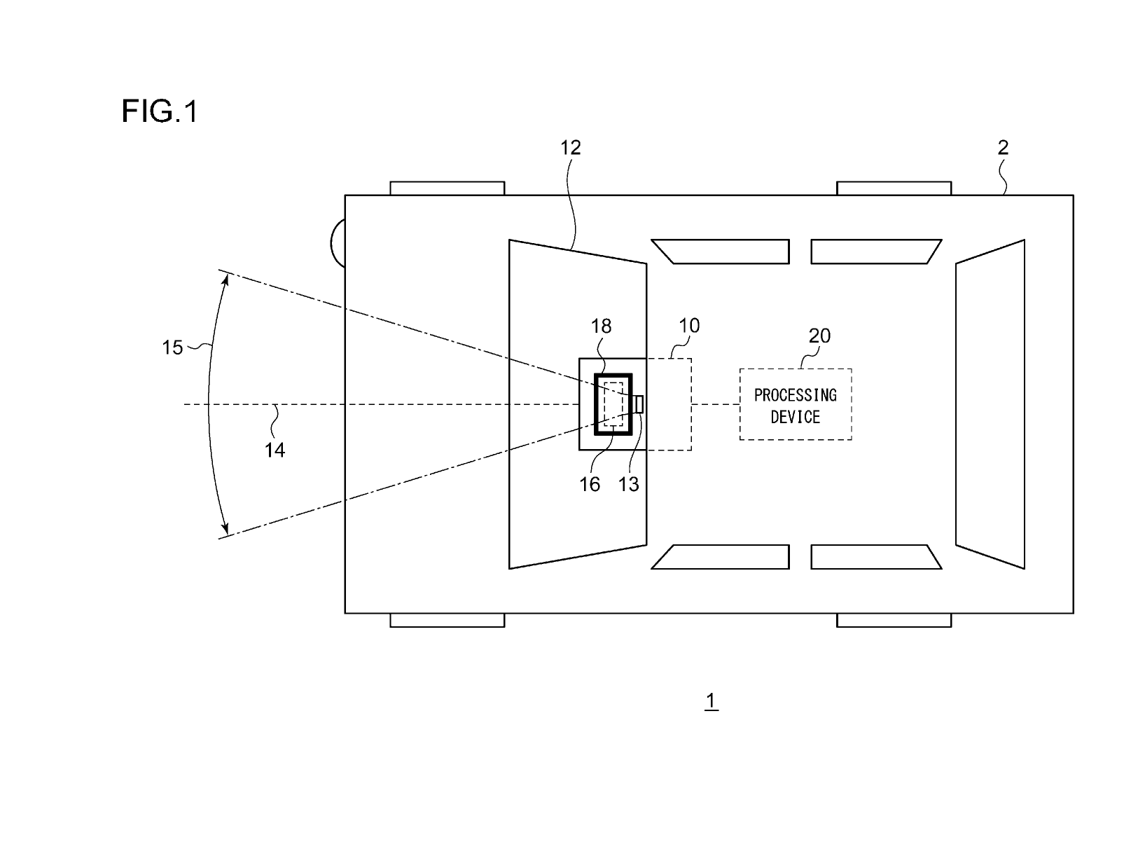

FIG. 1 shows an imaging system 1 mounted to a vehicle. The imaging system 1 according to an embodiment is provided with a camera 10, a temperature raising unit 18, and a processing device 20. The camera 10 is installed inside the vehicle and captures an image of objects outside the vehicle through the window of the vehicle 2. In the example shown in FIG. 1, the camera 10 captures an image of objects in front of the vehicle 2 through the front window 12. The camera 10 is provided with an imaging device 13 and may be configured as a monocular camera, stereo camera, or infrared camera. The camera 10 may be provided with an object detection sensor such as a laser sensor in addition to the imaging device 13. The housing of the camera 10 is attached to the front window 12, the rear-view mirror, or the vehicle ceiling such that a light axis 14 of the imaging device 13 faces a space in front of the vehicle.

The camera 10 captures an image of objects outside the vehicle periodically and supplies the captured image to the processing device 20. In FIG. 1, an imaging range 15 represents a horizontal viewing angle of the imaging device 13. An imaging area 16 represents a window area on the front window 12 included in the imaging range 15 of the camera 10, i.e., an area on the front window 12 imaged by the imaging device 13.

A temperature raising unit 18 is provided around the imaging area 16 in order to raise the temperature of at least the imaging area 16. For example, the temperature raising unit 18 may be a hot wire (heating wire) that generates heat in response to the electric power supplied thereto. The hot wire embodying the temperature raising unit 18 may be formed on the interior surface of the front window 12 or formed inside the front window 12. The hot wire embodying the temperature raising unit 18 may be formed within the imaging area 16 by using a transparent material instead of being formed around the imaging area 16. The temperature raising unit 18 may be provided in the camera 10. For example, the temperature raising unit 18 may be a hot wire provided in the hood (cover) of the housing of the camera 10 or may be configured to supply hot air to the imaging area 16. The temperature raising unit thus is a window heater that heats the imaging area of the window by directly generating heat in the window or by supplying heated air to the window.

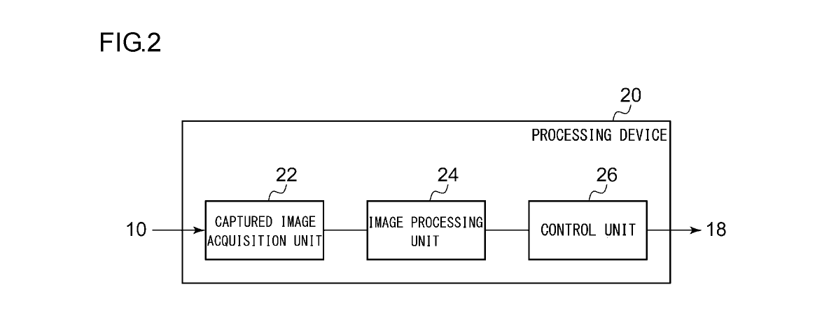

FIG. 2 shows the configuration of the processing device 20. The processing device 20 is provided with a captured image acquisition unit 22, an image processing unit 24, and a control unit 26. The elements depicted in FIG. 2 as functional blocks for performing various processes are implemented by hardware such as circuit blocks, memories and/or other LSI's, and by software such as programs etc., loaded into the memories. Therefore, it will be understood to those skilled in the art that the functional blocks may be implemented in a variety of manners by hardware only, software only, or a combination of thereof.

The captured image acquisition unit 22 acquires an image captured by the camera 10 periodically and supplies the image to the image processing unit 24. The image processing unit 24 is provided with the function of determining whether the image captured by the camera 10 is clear or blurred. That is, the image processing unit 24 has the function of determining whether the captured image is clear or unclear. The imaging area 16 on the front window 12 is imaged by the imaging device 13. If the imaging area 16 is fogged or is coated with ice, the imaging device 13 cannot capture an image of objects outside properly so that the captured image is blurred.

In the embodiment, the image captured by the camera 10 is used in the driving assistance process performed by the driving assistance system. The image processing unit 24 has the function of detecting an object such as a vehicle or a person in the captured image, for the purpose of the driving assistance process. More specifically, the image processing unit 24 detects an edge or a corner included in the captured image as a characteristic point and detects an object included in the captured image by using template matching. The image processing unit 24 may track the characteristic point in a plurality of temporally continuous captured images and detect information such as a speed difference between the object and the driver's vehicle. Based on such information, the driving assistance system performs the driving assistance process such as determining the possibility of collision between the detected object and the driver's vehicle and outputting an alert to the driver. Because characteristic points of a still object such as a structure are extracted from differences in a plurality of captured images, it is suitable that the vehicle 2 travels at a predetermined speed (e.g., 5 km/h) or higher in order to allow the image processing unit 24 to detect characteristic points.

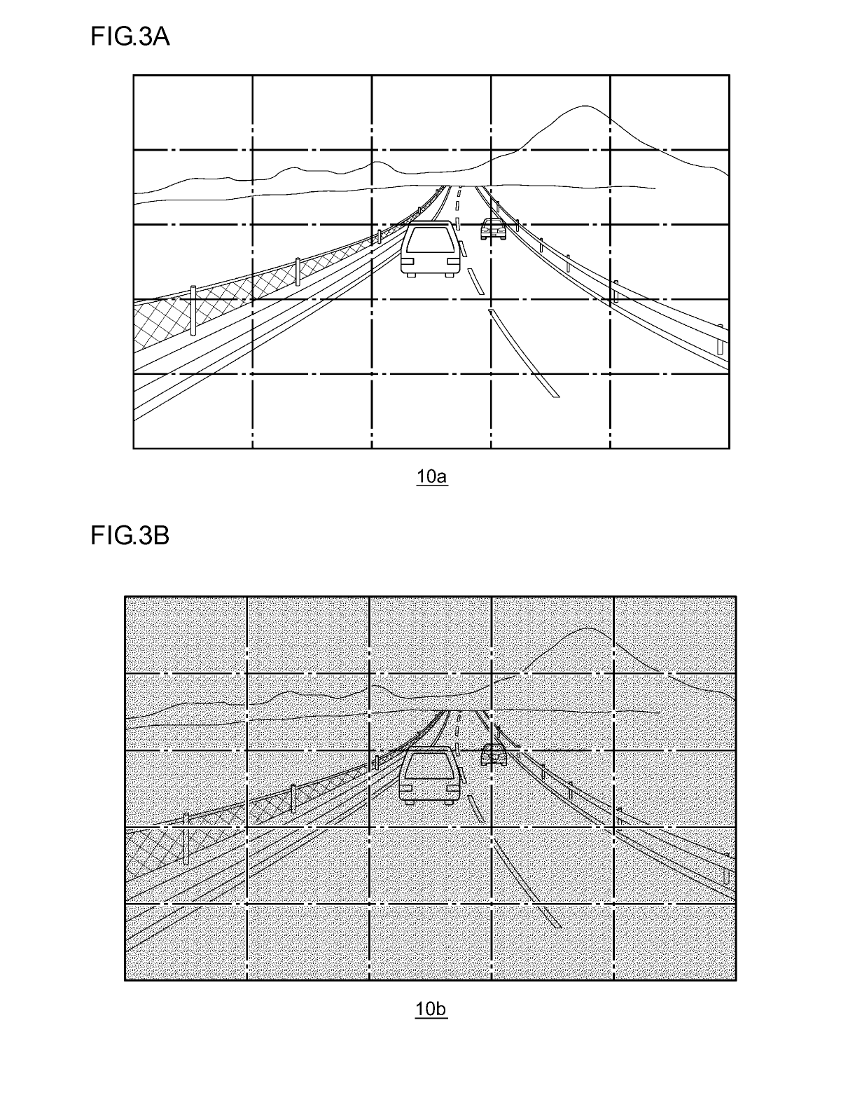

FIGS. 3A and 3B show examples of images captured by the camera 10. A captured image 10a shown in FIG. 3A is properly captured. The image processing unit 24 detects one or more characteristic points by analyzing the captured image 10a and detects one or more objects included in the captured image. Meanwhile, a captured image 10b shown in FIG. 3B is not captured properly so that the image processing unit 24 cannot detect a characteristic point properly from the captured image 10b.

In the event that a characteristic point cannot be properly detected in the captured image, the image processing unit 24 according to the embodiment determines that the captured image is unclear or blurred. For example, the image processing unit 24 segments the captured image into a plurality of areas as shown in FIGS. 3A and 3B. The image processing unit 24 identifies a segmented area in which a characteristic point is detected and a segmented area in which a characteristic point cannot be detected. In this example, the captured image is segmented into 25 (5×5) areas. Since the captured image 10a of FIG. 3A is captured properly, the image processing unit 24 detects characteristic points in all segmented areas. Meanwhile, the captured image 10b of FIG. 3B is not properly captured so that the image processing unit 24 cannot detect a characteristic point in some of the segmented areas in the captured image 10b. The image processing unit 24 according to the embodiment determines whether the captured image is clear or blurred in accordance with the number of segmented areas in which one or more characteristic points are detected and the number of segmented areas in which a characteristic point cannot be detected.

The image processing unit 24 may determine that the captured image is blurred if a characteristic point cannot be detected in a first predetermined proportion (Ru %) or more of the plurality of segmented areas. The image processing unit 24 may determine that the captured image is blurred if the number of areas in which a characteristic point cannot be detected amounts to 50% or more. If it is determined that the captured image is blurred, the image processing unit 24 turns a blur flag “on”.

In this example, the number of segmented areas is 25. Therefore, the image processing unit 24 determines that the captured image is blurred if it cannot detect a characteristic point in 13 or more segmented areas. Meanwhile, if the number of areas in which a characteristic point cannot be detected is less than 50% of the total number, i.e., if the number of areas in which a characteristic point cannot be detected is 12 or less, the image processing unit 24 determines that the captured image is clear.

After determining that the captured image is blurred, the image processing unit 24 determines whether the blurred state is dissolved (as used herein, “dissolved” means reduced or eliminated). If a characteristic point cannot be detected in a second predetermined proportion (RI %) or less of the plurality of segmented areas, the image processing unit 24 may determine that the blurred state of the captured image is dissolved. Thus, the image processing unit 24 is provided with the function of determining whether a captured image is clear or blurred, and the function of determining whether the blurred state of the captured image is dissolved. Hereinafter, the process performed by these functions will be referred to as “imaging state determination process”. Comparing a determination threshold Ru indicating the first predetermined proportion for determination that a captured image is blurred and a determination threshold RI indicating the second predetermined proportion for determination that the blurred state of the captured image is dissolved, the thresholds are set such that Ru>RI.

If RI and Ru are set to be equal, hunting instability may be induced in the result of determination in the imaging state determination process despite the fact that the state of the window remains unchanged. It is therefore suitable to stabilize the result of determination in the imaging state determination process by setting the thresholds such that Ru>RI. For example, the image processing unit 24 determines that the blurred state of the captured image is dissolved if the number of segmented areas in which a characteristic point cannot be detected is 30% or less of the total number of segmented areas. The image processing unit 24 turns the blur flag “off” if it determines that the blurred state of the captured image is dissolved.

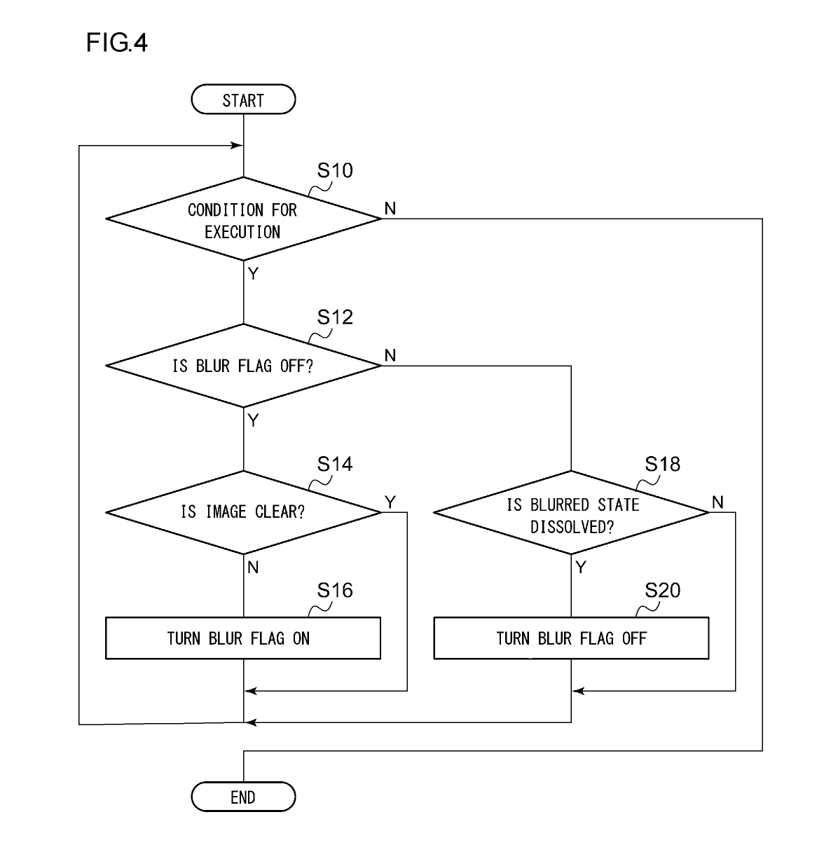

FIG. 4 is a flowchart showing the imaging state determination process. The imaging state determination process is executed while a condition for execution is fulfilled (Y in S10). The condition for execution at least requires that the start switch of the vehicle 2 is activated to turn ignition (IG) on. Detection of a characteristic point by the image processing unit 24 is suitably executed when the vehicle 2 is traveling at a predetermined speed (e.g., 5 km/h) or higher, Therefore, the imaging state determination process may be executed when IG is on and the vehicle 2 is traveling at a predetermined speed (e.g., 5 km/h) or higher. Initially, the blur flag is set “off”.

If the blur flag is off (Y in S12), the image processing unit 24 determines whether the captured image is clear or blurred (S14). If the image processing unit 24 cannot detect a characteristic point in the first predetermined proportion (Ru %) or more of the plurality of segmented areas, the image processing unit 24 determines that the captured image is blurred (N in S14). If the image processing unit 24 can detect a characteristic point in the first predetermined proportion or more of the segmented areas, the image processing unit 24 determines that the captured image is clear (Y in S14). Upon determining that the captured image is blurred, the image processing unit 24 turns the blur flag on (S16). The image processing unit 24 may determine that the captured image is blurred if it refers to a plurality of successive captured images in time sequence and finds that a characteristic point cannot be detected in the first predetermined portion (Ru %) or more of the segmented areas on successive occasions.

If the blur flag is on (N in S12), the image processing unit 24 determines whether the blurred state of the captured image is dissolved (S18). If the image processing unit 24 cannot detect a characteristic point in the second predetermined proportion (RI %) or less of the total number of segmented areas, the image processing unit 24 determines that the blurred state of the captured image is dissolved (Y in S18). If the image processing unit 24 cannot detect a characteristic point in more than the second predetermined proportion (RI %) of the segmented areas, the image processing unit 24 determines that the blurred state of the captured image is not dissolved (N in S18). When the image processing unit 24 determines that the blurred state of the captured image is dissolved, the image processing unit 24 turns the blur flag off (S20). The image processing unit 24 may determine that the blurred state of the captured image is dissolved if it refers to a plurality of successive captured images in time sequence and finds that a characteristic point cannot be detected in the second predetermined portion (RI %) or less of the segmented areas on successive occasions.

The imaging state determination process is executed until the condition for execution is no longer fulfilled (N in S10). The imaging state determination process is executed periodically to assist the driving based on the captured image. For example, the imaging state determination process may be executed at a period of 1 second or shorter. The imaging state determination process may be executed in conjunction with the process of detecting an object from the captured image. While the captured image is being determined to be blurred and the blur flag is being turned on, it is necessary to suspend the driving assistance process based on captured images.

The control unit 26 is notified by the image processing unit 24 of the result of determination as to whether the captured image is clear. The image processing unit 24 communicates the result of determination in the imaging state determination process executed at a predetermined period, i.e., the flag value of the blur flag, to the control unit 26. The flag value of the blur flag may be stored in a predetermined memory (not shown) so that the control unit 26 may refer to the flag value stored in the memory in synchronization with the imaging state determination process performed by the image processing unit 24. The control unit 26 monitors the flag value of the blur flag continuously.

Generally, the fog (condensation) on the window is created when the temperature outside the vehicle is low, the air temperature in the neighborhood of the window drops, and the moisture contained in the air in the neighborhood of the window is released to (condenses on) the window surface. Therefore, when the fog is created on the window, the control unit 26 activates the temperature raising unit 18 to raise the temperature in the imaging area 16, thereby removing the fog in the imaging area 16 immediately. Similarly, when the window is coated with ice, the control unit 26 activates the temperature raising unit 18 to remove the ice in the imaging area 16. If the temperature raising unit 18 is implemented by a hot wire, the control unit 26 generates heat by inducing an electric current in the hot wire. By setting the activation time of the temperature raising unit 18 to a first predetermined period of time (e.g., 3 minutes) that is sufficient to remove the fog or ice, the fog or ice in the imaging area 16 is removed so that the camera 10 can capture a clear image before the activation of the temperature raising unit 18 is suspended.

Even if the outside temperature is not low, the window may be fogged if the humidity in the vehicle is high due to, for example, rainy weather. This is addressed by the embodiment such that the control unit 26 determines that the vehicle on a trip is in a situation where the window is likely to be fogged if the captured image is determined to be blurred, i.e., if the blur flag is changed from off to on, and controls the temperature raising unit 18 to be alternately activated and deactivated periodically. By using the control unit 26 to control the temperature raising unit 18 to be alternately activated for the first predetermined period of time and deactivated for the second predetermined period of time, the imaging area 16 is prevented from being fogged. This can also reduce power consumption as compared to a case where the temperature raising unit 18 is continuously activated. Hereinafter, control of the temperature raising unit 18 by the control unit 26 will be referred to as “temperature raising control”. For example, the control unit 26 may control the temperature raising unit 18 to be alternately activated and deactivated at 3 minute intervals.

However, if the image processing unit 24 determines that the captured image is blurred because of the dirt on the window outer surface in the imaging area 16, the dirt is not removed by raising the temperature of the imaging area 16 so that the blurred state of the captured image is not dissolved. Thus, if the camera 10 cannot capture a clear image even after the temperature raising unit 18 has been activated for the first predetermined period of time, it is likely that the window is dirty instead of being fogged or coated with ice. For this reason, if the blurred state of the captured image is not dissolved by the time the first predetermined period of time (e.g., 3 minutes) elapses since the temperature raising unit 18 is activated, the control unit 26 deactivates the temperature raising unit 18 when the first predetermined period of time elapses and prohibits the subsequent activation of the temperature raising unit 18. This can avoid a situation where the temperature raising unit 18 is activated unnecessarily and electric power is consumed wastefully. In this process, the control unit 26 turns an activation prevention flag “on” so as to ensure that the temperature raising unit 18 cannot be activated while the activation prohibition flag is on. Initially, the activation prohibition flag is set “off”. Once the activation prevention flag is turned “on”, the control unit 26 does not activate the temperature raising unit 18 until such time that the activation prohibition flag is changed to “off”.

The driver may wipe off dirt on the window outer surface in the imaging area 16 by causing a wiper to move. When the dirt is wiped off, the camera 10 can capture a clear image so that the image processing unit 24 can suitably detect one or more characteristic points such as an edge or a corner from the captured image. For this reason, if the image processing unit 24 determines that the blurred state of the captured image is dissolved while the activation of the temperature raising unit 18 is being prohibited, the image processing unit 24 turns the blur flag “off”. In response to the transition from “on” to “off” of the blur flag, the control unit 26 turns the activation prohibition flag “off”. When the activation prohibition flag is turned off, the control unit 26 cancels the prohibition of activation of the temperature raising unit 18, i.e., returns to a state in which the control unit 26 can activate the temperature raising unit 18.

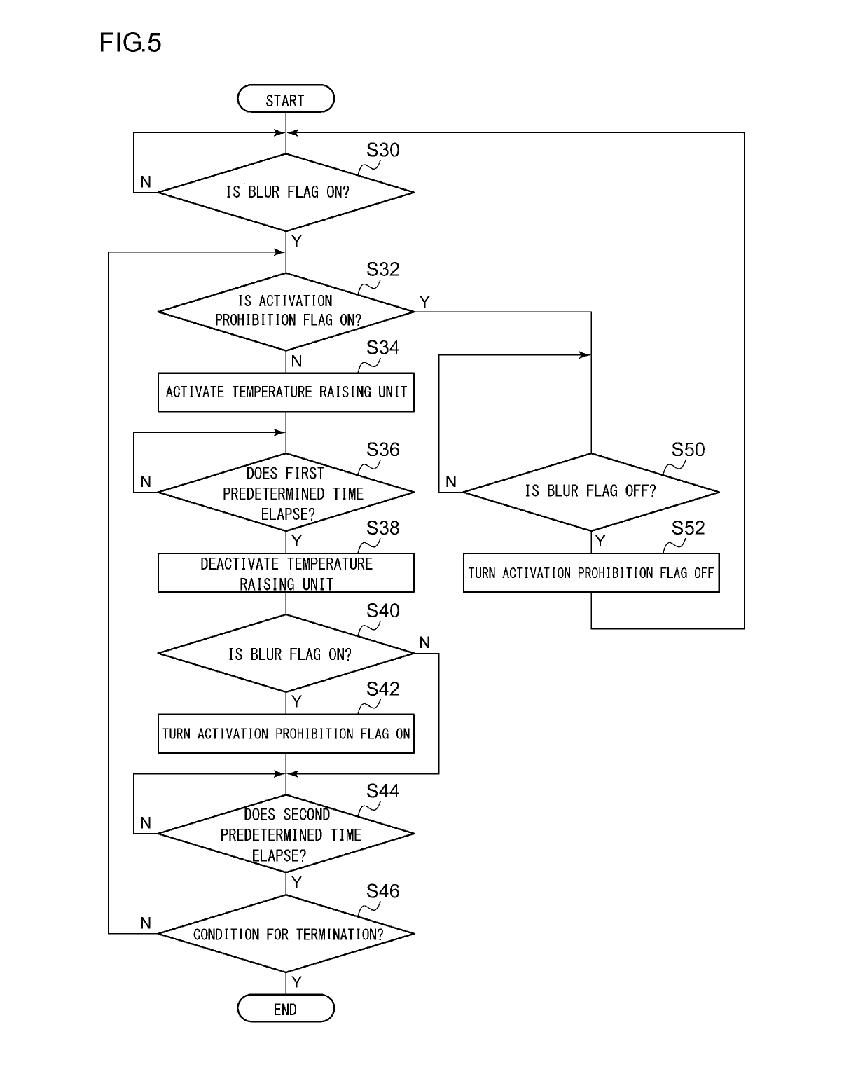

FIG. 5 is an exemplary flowchart for temperature raising control. Temperature raising control is started when the start switch of the vehicle 2 is activated to turn ignition (IG) on. Temperature raising control may be started when ignition is on and when the vehicle 2 travels at a predetermined speed (e.g., 5 km/h) or higher. It is suitable that the predetermined speed is set to a level that allows the image processing unit 24 to execute the characteristic point detection process.

The control unit 26 monitors the flag value of the blur flag, and, more specifically, monitors whether a transition from “off” to “on” of the blur flag occurs (S30). Monitoring in S30 is continued while the blur flag is off (N in S30). When the blur flag is turned on (Y in S30), the control unit 26 determines whether the activation prohibition flag is on (S32). If the activation prohibition flag is off (N in 832), the control unit 26 activates the temperature raising unit 18 (S34) so as to raise the temperature in the imaging area 16 of the front window 12. The control unit 26 activates the temperature raising unit 18 until the first predetermined period of time elapses (N in S36).

When the first predetermined period of time elapses since the activation of the temperature raising unit (Y in S36), the control unit 26 deactivates the temperature raising unit 18 (S38) and refers to the flag value of the blur flag at the time when the first predetermined period of time elapses (S40). The step in S40 is an activation determination process for determining whether the temperature raising unit 18 can be activated or not subsequently. It should be noted that the imaging state determination process performed by the image processing unit 24 and temperature raising control performed by the control unit 26 are executed based on the same clock. The imaging state determination process is executed periodically. The step of determining whether the first predetermined period of time elapses (Y in S36) and the steps of S38 and S40 are executed when the result of determination in the imaging state determination process is generated. Therefore, the flag value of the blur flag referred to by the control unit 26 indicates the result of determination yielded by the image processing unit 24 when the first predetermined period of time elapses. If the blur flag is turned off, i.e., if the image processing unit 24 determines that the captured image is clear when the first predetermined period of time elapses since the temperature raising unit 18 is activated (N in S40), the control unit 26 knows that the fog on the window is suitably removed and maintains the “off” state of the activation prohibition flag so as to maintain the state in which the temperature raising unit 18 can be activated.

Meanwhile, if the blur flag is on, i.e., if the image processing unit 24 determines that the blurred state of the captured image is not dissolved when the first predetermined period of time elapses since the temperature raising unit 18 is activated (Y in S40), the control unit 26 turns the activation prohibition flag “on” so as to prohibit the subsequent activation of the temperature raising unit 18 (S42). If the blurred state of the captured image is not dissolved after the temperature raising unit 18 is activated for the first predetermined period of time, it is considered that the imaging area 16 is dirty with, for example, mud. If the imaging area 16 is dirty, the dirt is not removed even if the temperature raising unit 18 is activated, Therefore, the control unit 26 reduces wasteful consumption of electric power by turning the activation prohibition flag on so as to prohibit the subsequent activation of the temperature raising unit 18.

The control unit 26 deactivates the temperature raising unit 18 until the second predetermined period of time elapses (N in S44) after the temperature raising unit 18 is turned to be deactivated. When the second predetermined period of time elapses (Y in S44), control is returned to S32 if the condition for termination is not fulfilled (N in S46). If the condition for termination is fulfilled (Y in S46), temperature raising control by the control unit 26 is terminated. The condition for termination in S46 may require that the vehicle ignition is turned off. In the flowchart shown in FIG. 5, S46 is illustrated as a step following S44 for convenience. Determination on the condition of termination in S46 is made at all times after temperature raising control is started. When the condition for termination is determined to be fulfilled, temperature raising control by the control unit 26 is terminated.

Referring back to S32, the control unit 26 determines whether the activation prohibition flag is on. If the activation prohibition flag is off (N in S32), the control unit 26 executes the process between S34-S44 described above. More specifically, the control unit 26 activates the temperature raising unit 18 for the first predetermined period of time to raise the temperature in the imaging area 16 and deactivates the temperature raising unit 18 for the second predetermined period of time.

If the activation prohibition flag is on (Y in S32), the control unit 26 does not activate the temperature raising unit 18. The control unit 26 monitors the flag value of the blur flag. More specifically, the control unit 26 monitors whether the blur flag makes a transition from “on” to “off” (S50). Monitoring in S50 is continued while the blur flag is on (N in S50). When the blur flag is off (Y in S50), the control unit 26 turns the activation prohibition flag off (S52). More specifically, if the image processing unit 24 determines that the blurred state of the captured image is dissolved while the activation of the temperature raising unit 18 is being prohibited, the control unit 26 cancels the prohibition of activation of the temperature raising unit 18. This returns the control unit 26 to a state in which it can activate the temperature raising unit 18.

In the embodiment, temperature raising control for repeating the activation and deactivation of the temperature raising unit 18 is performed in response to the change of the blur flag from off to on (Y in S30) and a determination that the vehicle on a trip is in a situation where the window is likely to be fogged. Thus, when the activation prohibition flag is turned on, it is known that the cause for the blurred captured image is the dirt attached on the window outer surface. It is unknown whether the vehicle on a trip is in a situation where the window is likely to be fogged. Therefore, the control unit 26 executes the process of monitoring the blur flag in S30 again after the activation prohibition flag is changed from on to off so as to determine whether the vehicle on a trip is in a situation where the window is likely to be fogged. Temperature raising control described above is executed until the condition for termination is fulfilled (Y in S46).

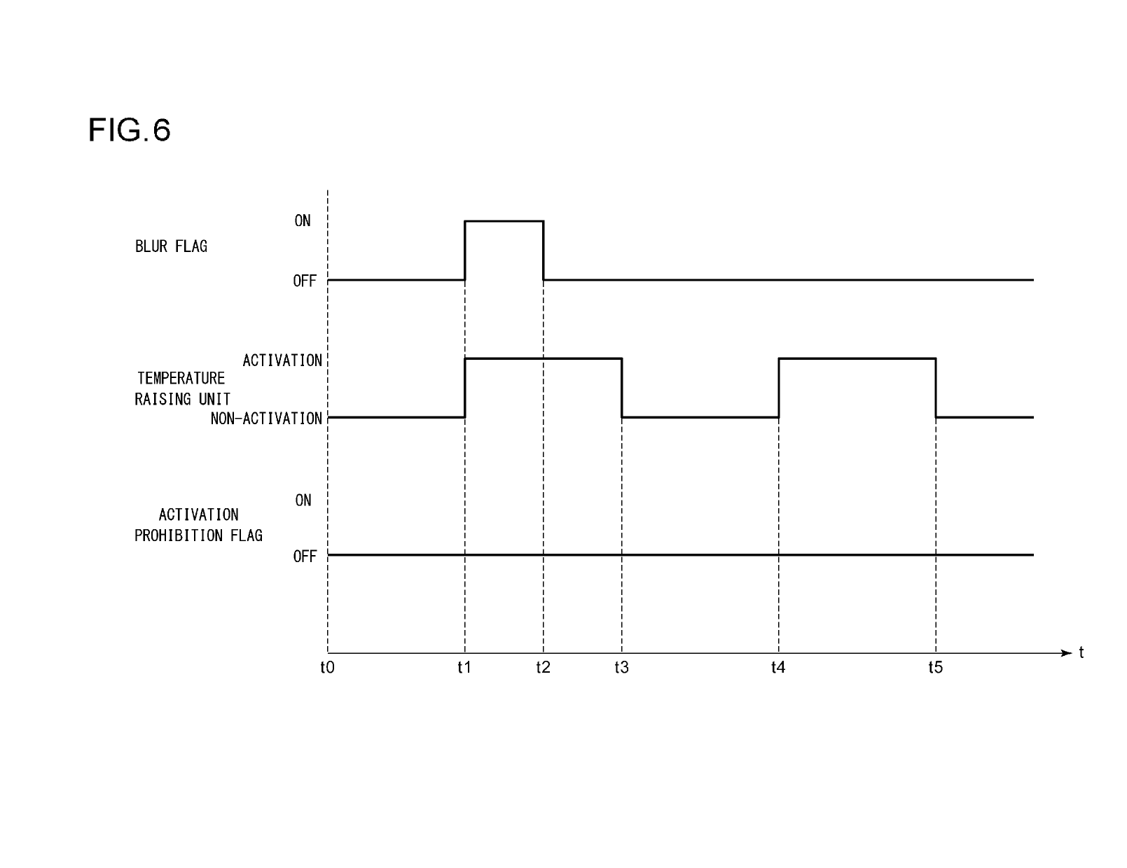

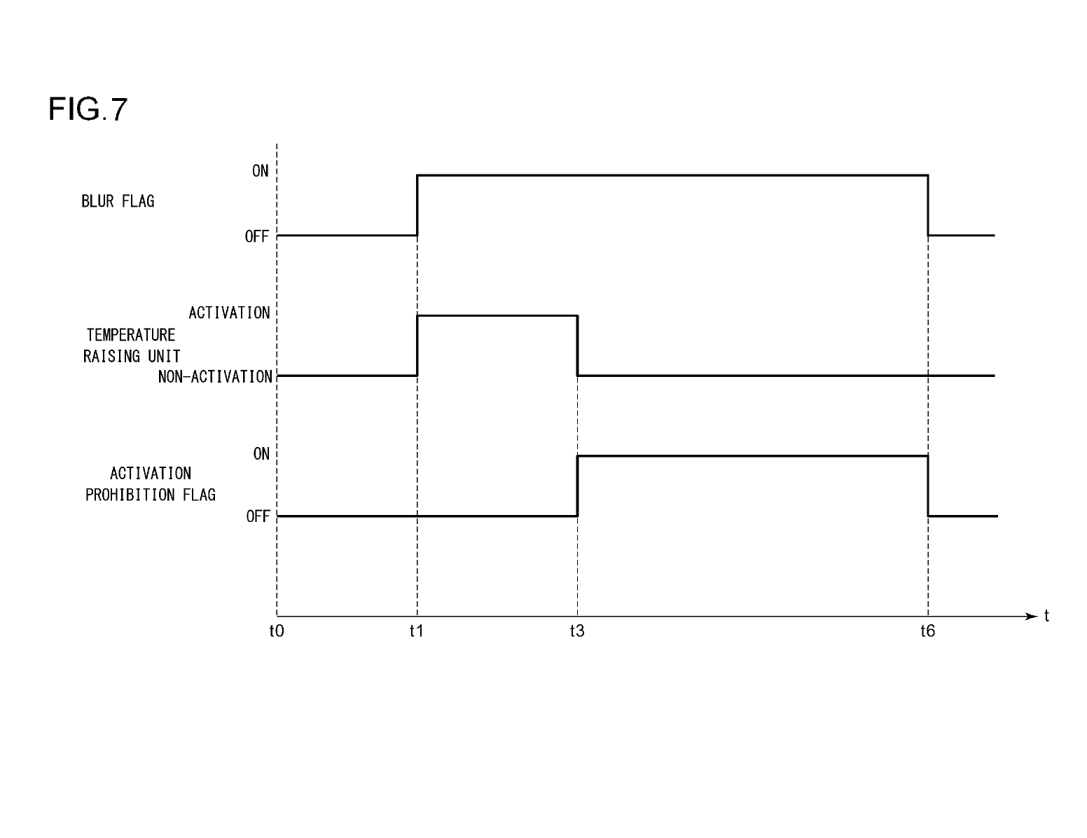

FIGS. 6 and 7 are timing charts for temperature raising control. FIG. 6 is a timing chart in which a clear image is captured by the time the first predetermined period of time elapses since the temperature raising unit 18 is started to be activated. FIG. 7 is a timing chart in which the blurred state of the captured image is not dissolved by the time the first predetermined period of time elapses since the temperature raising unit 18 is started to be activated.

A description will now be given of the timing chart of FIG. 6. At time t1, the image processing unit 24 determines that the captured image is blurred and turns the blur flag on. As the blur flag is turned on, the control unit 26 activates the temperature raising unit 18. At time t2, the image processing unit 24 determines that the blurred state of the captured image is dissolved and turns the blur flag off. The control unit 26 activates the temperature raising unit 18 for the first predetermined period of time (t3−t1) and suspends the activation of the temperature raising unit 18 at time t3. The control unit 26 deactivates the temperature raising unit 18 for the second predetermined period of time (t4−t3). After time t4, the control unit 26 activates and deactivates the temperature raising unit 18 periodically.

Referring to the timing chart shown in FIG. 6, the blurred state of the captured image is dissolved at time t2 by raising the temperature in the imaging area 16. Therefore, the activation prohibition flag is not turned on and the control unit 26 can activate the temperature raising unit 18 after time t4.

A description will now be given of the timing chart of FIG. 7. At time t1, the image processing unit 24 determines that the captured image is blurred and turns the blur flag on. As the blur flag is turned on, the control unit 26 activates the temperature raising unit 18. The control unit 26 activates the temperature raising unit 18 for the first predetermined period of time (t3−t1). At time t3, the control unit 26 suspends the activation of the temperature raising unit 18. At time t3, the blur flag is on and the blurred state of the captured image is not dissolved even after the temperature raising unit 18 has been activated for the first predetermined period of time. Therefore, the control unit 26 turns the activation prohibition flag on. When the activation prohibition flag is turned on, the activation of the temperature raising unit 18 is prohibited so that the control unit 26 continues to suspend temperature raising control after time t3.

Subsequently, when the dirt on the front window 12 is wiped off by the wiper at time t6, the image processing unit 24 determines that the blurred state of the captured image is dissolved and turns the blur flag off. This causes the control unit 26 to turn the activation prohibition flag off so that the control unit 26 returns to a state in which it can activate the temperature raising unit 18 after time t6. Thus, if the image processing unit 24 determines that the blurred state of the captured image is dissolved while the activation of the temperature raising unit 18 is being prohibited, the control unit 26 cancels the prohibition of activation of the temperature raising unit 18 and is placed in a state in which it can activate the temperature raising unit 18. Thus, by canceling the prohibition of activation of the temperature raising unit 18 once the dirt in the imaging area 16 is removed, the temperature raising unit 18 can be suitably activated when the captured image becomes blurred.

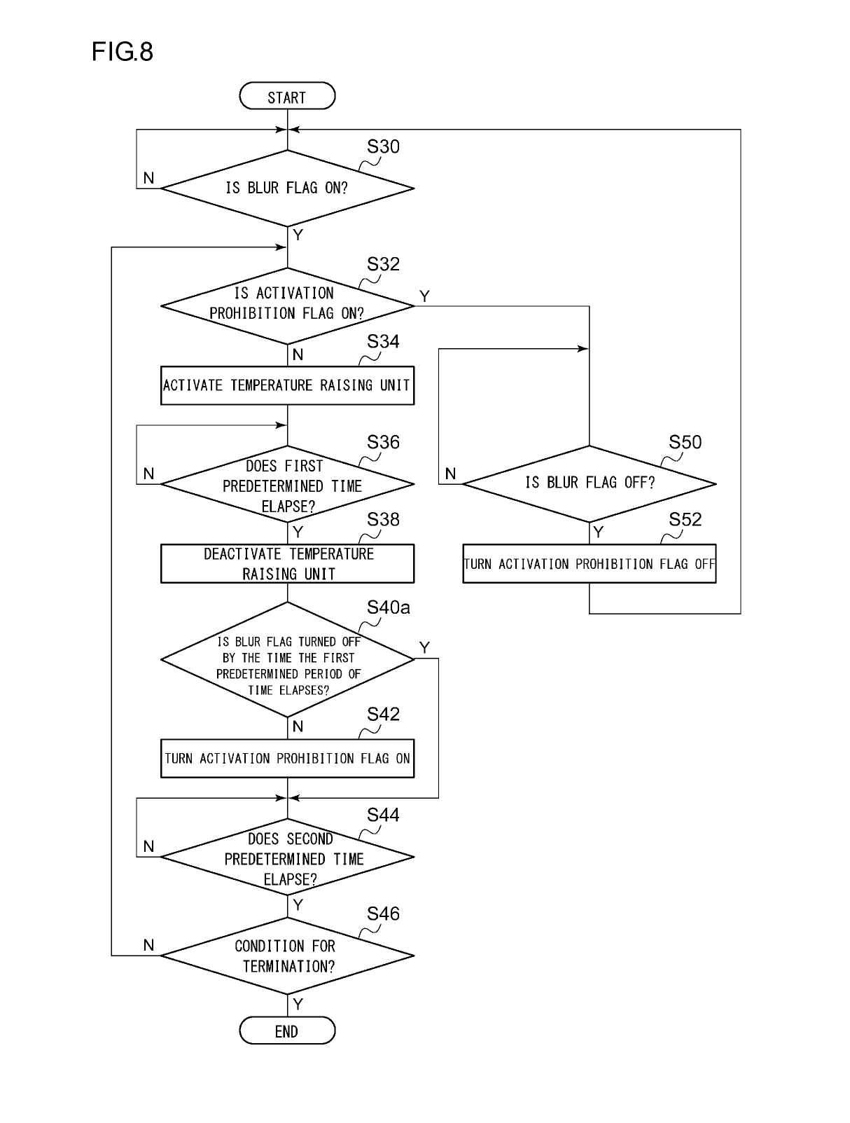

FIG. 8 is another exemplary flowchart for temperature raising control by the control unit 26. Compared with the flowchart of FIG. 5, the flowchart of FIG. 8 differs in that the activation determination process of S40 in FIG. 5 is changed to S40a. The other steps remain unchanged.

In the temperature raising control shown in FIG. 8, the control unit 26 activates the temperature raising unit 18 for the first predetermined period of time. After suspending the activation of the temperature raising unit 18, the control unit 26 determines whether the blur flag has been turned off at least once for the first predetermined period of time during which the temperature raising unit 18 is being activated (S40a). More specifically, the control unit 26 determines whether the image processing unit 24 determined that the blurred state of the captured image is dissolved by the time the first predetermined period of time elapses since the temperature raising unit 18 is activated. As described above, the imaging state determination process by the image processing unit 24 and temperature raising control by the control unit 26 are executed based on the same clock. The imaging state determination process is executed at predetermined intervals until the first predetermined period of time elapses (N in S36). By the time the first predetermined period of time elapses (Y in S36), the control unit 26 refers to the result of determination in the imaging state determination process in synchronization with the clock for generating the result of determination, so as to determine whether the blur flag is turned off. For example, the determination as to whether the first predetermined period of time elapses may be made at the same period as the period for the imaging state determination process. The control unit 26 may refer to the flag value of the blur flag each time that the control unit 26 makes the determination as to whether the first predetermined period of time elapses (N in S36). When the blur flag is turned off, the control unit 26 stores information indicating that the flag is turned off in a memory (not shown). The control unit 26 may see whether the information indicating that the flag is turned off is stored in the memory when it is determined that the first predetermined period of time elapses (Y in S36) so as to determine whether the blur flag was turned off in the past. Thus, the control unit 26 determines whether the blur flag was turned off in the past before the first predetermined period of time elapses (S40a).

If the image processing unit 24 determines that the blurred state of the captured image is dissolved by the time the first predetermined period of time elapses since the temperature raising unit 18 is activated (Y in 40a), the control unit 26 maintains the activation prohibition flag “off”. Thereby, the control unit 26 maintains the state in which it can activate the temperature raising unit 18 and does not prohibit the activation of the temperature raising unit 18 after the elapse of the first predetermined period of time. This is because it can be determined that the captured image was blurred because of the fog or ice coating on the window instead of the dirt on the window, since the captured image became clear at least once while the temperature raising unit 18 is being activated.

Meanwhile, if the image processing unit 24 cannot determine that the blurred state of the captured image is dissolved by the time the first predetermined period of time elapses since the temperature raising unit 18 is activated (N in S40a), the control unit 26 turns the activation prohibition flag “on” (S42). If the blur flag is never turned off while the temperature raising unit 18 is being activated, it can be determined that the captured image was blurred because of the dirt on the window. Therefore, the control unit 26 prohibits the subsequent activation of the temperature raising unit 18 and stops the temperature raising control.

It is described above that the control unit 26 prohibits the activation of the temperature raising unit 18 if the blurred state of the captured image is not dissolved by the time the first predetermined period of time elapses since the temperature raising unit 18 became activated. The embodiment is intended to be illustrative only and it will be obvious to those skilled in the art that various modifications to constituting elements and processes could be developed and that such modifications are also within the scope of the present disclosure.

As described in the embodiment, the fog on the window is produced as the moisture contained in the air in the neighborhood of the window is released to (condensed on) the window surface when the outside temperature is low. In this respect, the vehicle 2 may be provided with a temperature sensor for measuring the outside temperature, and the control unit 26 may subject the temperature raising unit 18 to temperature raising control by determining that the window is likely to be fogged when the outside temperature measured by the temperature sensor is equal to or lower than a predetermined temperature. In this case, too, the control unit 26 prohibits the activation of the temperature raising unit 18 if the activation prohibition flag is on.

By way of example, the camera 10 according to the embodiment is mounted to the vehicle 2 so as to capture an image of objects in front of the vehicle. Alternatively, the camera 10 may be mounted to the vehicle 2 so as to capture an image of objects in other directions (e.g., objects behind or lateral to the vehicle).

What is claimed is:

1. An imaging system configured to be mounted to a vehicle, the imaging system comprising:
a camera configured to capture an image of objects outside the vehicle through a window of the vehicle;
a window heater configured to raise a temperature of at least a window area included in an imaging range of the camera;
an image processor configured to determine whether a captured image captured by the camera is clear or blurred; and
a controller configured to activate the window heater to raise the temperature of the window area when the image processor determines that the captured image is blurred, wherein
when a blurred state of the captured image is not reduced by a time that a predetermined period of time elapses since the window heater is activated, the controller suspends activation of the window heater once the predetermined period of time has elapsed, and prohibits subsequent activation of the window heater.

2. The imaging system according to claim 1, wherein
the image processor determines whether the blurred state of the captured image has been reduced, and
when the image processor determines that the blurred state of the captured image has not been reduced once the predetermined period of time has elapsed since the window heater is activated, the controller prohibits the subsequent activation of the window heater.

3. The imaging system according to claim 1, wherein
the image processor determines whether the blurred state of the captured image has been reduced, and
when the image processor determines that the blurred state of the captured image has been reduced before the predetermined period of time has elapsed since the window heater is activated, the controller does not prohibit the subsequent activation of the window heater after the predetermined period of time has elapsed.

4. The imaging system according to claim 1, wherein
when the image processor determines that the blurred state of the captured image has been reduced while the activation of the window heater is being prohibited, the controller cancels the prohibition of the subsequent activation of the window heater.
